(19) United States
(12) Patent Application Publication
(10) Pub. No.: US 2024/0280798 A1
(43) Pub. Date: Aug. 22, 2024

(54) DATA PROCESSING APPARATUS FOR A DIGITAL IMAGING DEVICE, MICROSCOPE AND MICROSCOPY METHOD

(71) Applicant: LEICA MICROSYSTEMS CMS GMBH, Wetzlar (DE)

(72) Inventors: Falk SCHLAUDRAFF, Wetzlar (DE); Sam STEBLAU, Wetzlar (DE); Eugen NORDHEIMER, Wetzlar (DE); Bernd WIDZGOWSKI, Wetzlar (DE)

(21) Appl. No.: 18/443,399

(22) Filed: Feb. 16, 2024

(30) Foreign Application Priority Data
Feb. 20, 2023 (DE) 102023104144.4

(51) Int. Cl. G02B 21/36; H04N 23/76; H04N 23/81

(52) U.S. Cl. CPC G02B 21/365; H04N 23/76; H04N 23/81

(57) ABSTRACT

An apparatus for data processing for a digital imaging device is provided. The digital imaging device is configured to generate a digital image of a recording region by reading out, raster-element-by-raster-element, a multidimensional complete raster. The complete raster includes a plurality of raster elements. The apparatus is part of a control unit of the imaging device or is configured to be controllable by the control unit of the imaging device. The apparatus is configured to process raw image data from at least one sub-region of the complete raster that has already been read out during the reading out, generate processed image data in at least one processing step as a function of the raw image data, and make the processed image data available for display for access from outside the apparatus.

### CROSS REFERENCE TO RELATED APPLICATIONS

This application claims benefit to German Patent Application No. DE 102023104144.4, filed on Feb. 20, 2023, which is hereby incorporated by reference herein.

### FIELD

Embodiments of the present invention relate to a data processing apparatus for a digital imaging device, for example, but not exclusively, a microscope, in particular a light imaging microscope, for example a confocal laser scanning microscope. Embodiments of the present invention also relate to a microscope and a microscopy method.

### BACKGROUND

In many areas of research, science and technology, imaging devices are used to generate images of one or more objects under investigation in a recording region. Depending on the application area, imaging devices are used here that are based on a functional principle of successively scanning or sampling the recording region. Such imaging devices typically allow for depicting the objects under investigation in a high level of detail.

The disadvantage with investigating objects with such imaging devices is the comparatively long time required. There is, therefore, a need to remove this disadvantage.

### SUMMARY

Embodiments of the present invention provide an apparatus for data processing for a digital imaging device. The digital imaging device is configured to generate a digital image of a recording region by reading out, raster-element-by-raster-element, a multidimensional complete raster. The complete raster includes a plurality of raster elements. The apparatus is part of a control unit of the imaging device or is configured to be controllable by the control unit of the imaging device. The apparatus is configured to process raw image data from at least one sub-region of the complete raster that has already been read out during the reading out, generate processed image data in at least one processing step as a function of the raw image data, and make the processed image data available for display for access from outside the apparatus.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an imaging device with an apparatus according to a first exemplary embodiment;

FIG. 2 shows a schematic representation of a further imaging device with an apparatus according to a second exemplary embodiment;

FIG. 3 shows a schematic representation of a further imaging device with an apparatus according to a third exemplary embodiment;

FIG. 4 shows a schematic representation of a further imaging device with an apparatus according to a fourth exemplary embodiment;

FIG. 5 shows a schematic representation of a further imaging device with an apparatus according to a fifth exemplary embodiment;

FIG. 6 shows a schematic flow diagram of a method according to an exemplary embodiment;

FIG. 7 shows a schematic representation of a detail of the flow diagram in FIG. 6 according to some embodiments;

FIG. 8 a schematic representation of a detail of the flow diagram in FIG. 7 according to some embodiments; and

FIG. 9 a schematic representation of a further imaging device with an apparatus according to a sixth exemplary embodiment.

### DETAILED DESCRIPTION

Embodiments of the present invention provide means by which work on imaging devices of the above type can be made more time saving.

Embodiments of the present invention provide a data processing apparatus for a digital imaging device that is designed to generate a digital image of a recording region by reading out, raster-element-by-raster-element, a multidimensional complete raster, including a plurality of raster elements, wherein the apparatus is part of a control unit installed in the imaging device or is designed to be controllable by a control unit of the imaging device. Furthermore, the apparatus is designed to process raw image data from at least one already read-out sub-region of the complete raster during the read-out, to generate processed image data in at least one processing step as a function of the raw image data and to make the processed image data available for display for access from outside the apparatus.

Upon reading out raster-element-by-raster-element, the individual raster elements are read out separately from one another in terms of time and/or location, for example pixel-by-pixel, voxel-by-voxel, line-by-line or plane-by-plane. The processing of the raw image data includes, in particular, obtaining, reading out, retrieving, querying or receiving the raw image data from the at least one already read-out sub-region of the complete raster.

Embodiments of the present invention are advantageous because the data processing by means of the apparatus can accompany the inherently time-consuming reading-out process. This saves time by processing the first raw image data as soon as they are available. This is advantageous, for example, with regard to downstream image data processing steps, since the image data processing steps can be started at an early stage. Accordingly, the at least one processing step can be an image data processing step. However, other processing steps can also be effected.

As will be explained in more detail below, the availability from outside the apparatus advantageously enables the generation of a preview and/or the checking of the prevailing recording parameters and device settings while the reading-out process is still running. Thus, the repetition rate due to incorrect recordings can be reduced, which also leads to significant time savings.

A computer-implemented method comprising the steps of obtaining raw image data representing at least one already read-out sub-region of a complete raster of a digital imaging device including a plurality of raster elements, generating processed image data in at least one processing step depending on the raw image data and providing the processed image data for display achieves the object set out at the beginning. In particular, the first raw image data are obtained before a complete image is generated by the imaging device. For example, the first raw image data from a 3×3 sub-region are obtained as soon as the fourth pixel in the third line of the complete raster has been read out.

Advantageously, with the computer-implemented method, the generation of processed image data can begin without significant delay as soon as the first raw image data have been obtained. From now on, further processed image data can be generated while the complete raster is being read out.

According to a first possible embodiment of the invention, the apparatus can be designed to process the raw image data before the complete raster is completely read out. The advantage of this is that there is no need to wait for the reading-out process to be completed.

The apparatus according to embodiments of the invention can be provided in particular for a digital light imaging microscope, for example a confocal laser scanning microscope, which is designed to scan the recording region and generate an image of the recording region built up raster-element-by-raster-element. The control unit can be designed accordingly to control movable elements, such as objectives, lenses, adjustment mimics, a microscope stage or attachment of the light imaging microscope. Given that the apparatus is part of the pre-existing control unit or can be controlled by the pre-existing control unit, the number of assemblies required in the light imaging microscope can be reduced or at least does not have to be increased unnecessarily.

The recording region can be a sample volume of the light imaging microscope with an object or specimen. Here, the complete raster can be a region of the sample volume to be scanned by the scanning points of the light imaging microscope.

Alternatively, the complete raster can be formed by an area sensor or array. In particular, sensor elements of a CCD sensor or a CMOS sensor can form the complete raster.

In general, the complete raster can be three dimensional or two dimensional. The complete raster can also include a plurality of sub-regions. Accordingly, each sub-region can represent a two-dimensional or three-dimensional array of data of a predetermined size. Here, the size of each sub-region can be constant or variable. Thus, each sub-region includes a plurality of raster elements in a constant or variable number. The raw image data are processed as soon as all raster elements of a first sub-region have been read out. Other raster elements that do not belong to the first sub-region may have been read out previously.

Here, the aforementioned image of the recording region represents a complete image. The apparatus thus has means for executing the above processes during the generation of the complete image. Upon generating the complete image, all raster elements of the complete raster are exposed and read out. The raw image data in the form of, for example, monochrome brightness values, RGB values or a histogram of a decay curve are linked to each raster element of the complete raster upon exposure and reading out. Here, the raw image data can be arranged in a three-dimensional or two-dimensional matrix.

The apparatus can be designed to assemble the processed image data generated from already read-out sub-regions into at least one continuously updated digital partial image of the image or complete image. This creates the possibility of obtaining a preview with which, for example, it can be checked whether the imaging device is aimed at the object or specimen as desired. This prevents time-wasting incorrect recordings and the processed image data can then be combined to form the complete image.

According to a further possible embodiment, the apparatus can have an image processor embedded in the imaging device and/or at least one integrated circuit, in particular a field programmable gate array (FPGA). The at least one processing step can be executed accordingly in the embedded image processor and/or in the integrated circuit.

Consequently, the complete structural integration of the apparatus into the imaging device is possible. Alternatively, it is of course also possible to operate the apparatus as a component external to the imaging device. Integration is then purely functional.

The embedded image processor can be a so-called embedded image processor. The integrated circuit can preferably be an integrated circuit, in particular a so-called single-board FPGA. Consequently, no external computer (for example, a PC) is required for this embodiment.

To speed up the calculations, a plurality of image processors and/or circuits can also be connected in parallel in the apparatus.

According to a further possible embodiment, the at least one processing step can comprise filtering the raw image data of the at least one already read-out sub-region with a filter mask. The filter results then produce the processed image data, for example.

With a two-dimensional complete raster, the filter mask can have at least the format 3×3, 1×3, 4×4 or 5×5. For a three-dimensional complete raster, the filter mask can have at least the format 3×3×3, 1×1×3, 4×4×4 or 5×5×5. Furthermore, the filter mask can be designed to be cross-shaped or approximately circular or spherical. Here, the format A×B×C describes the fact that the filter mask is applied to a sub-region that is A raster elements high, B raster elements wide and C raster elements deep. Preferably, the filter mask is applied to more than 500 raster elements (for example, pixels or voxels) at the same time.

If the raw image data are arranged in the matrix mentioned above, filtering can be effected by matrix multiplication with a two-dimensional or three-dimensional filter matrix. Here, the matrix coefficients of the filter matrix can remain constant. Thus, matrix multiplication involves comparatively little computational complexity and can be easily implemented on the embedded image processor and/or the at least one integrated circuit. A description of an exemplary calculation rule for matrix multiplication can be found in the following description of figures.

Optionally, the matrix coefficients can be variable depending on the raw image data, for example depending on a signal-to-noise ratio, in particular a local signal-to-noise ratio, which is calculated from the raw image data. Due to the adjustment of the matrix coefficients to the raw image data, this embodiment is characterized by an improved filtering result.

Alternatively or additionally, the at least one processing step can comprise noise suppression, which improves the quality of the processed image data. Noise suppression can be effected, for example, by deconvolution or inversion of a convolution operation on the raw image data. A description of an exemplary calculation rule for noise suppression can be found in the following description of figures.

According to a further possible embodiment, the apparatus can be designed to update the filter mask as a function of the raw image data of the sub-region that has already been read out. Furthermore, the apparatus can be designed to update the filter mask depending on the position and/or geometry of the already read-out sub-region. For example, a different filter mask than in the core of the complete raster can be used near the edge of the complete raster.

These updates can be effected in real time in each case. Here, the filter mask is preferably updated sub-region-by-sub-region, i.e., from sub-region to sub-region, from partial image to partial image and/or from complete image to complete image. In other words, an updated filter mask is used for each sub-region. The filter mask can also always be updated before a new partial image or a new complete image is generated.

The updating of the filter mask can be effected by a calculation based on the raw image data and/or the processed image data. With the aforementioned matrix multiplication, the update comprises adjusting the matrix coefficients and/or the size of the filter matrix. For example, in the case of a three-dimensional complete raster that is read out plane-by-plane, the filter matrix used can initially be two dimensional as long as only raster elements of one plane have been read out. As soon as a plurality of planes have been at least partially read out, the filter matrix can be expanded three-dimensionally.

Optionally, the updating of the filter mask can be effected by obtaining, reading out and receiving an adjusted filter mask. In particular, an adaptive filter mask, which is updated using a process based on machine learning or artificial intelligence, can be used here.

According to a further embodiment, the apparatus can be designed to associate metadata with the at least one sub-region, which metadata are calculated as a function of raw image data linked to each raster element of the at least one sub-region. For example, an average value of the brightness over all raster elements of the sub-region can be associated with the at least one sub-region. Thus, additional information content that is only indirectly derived from the raw image data can be made accessible.

Here, the metadata can be calculated directly or indirectly from the raw image data. In indirect calculation, metadata are determined based on other metadata that were previously calculated from the raw image data. The previously calculated metadata include, for example, metadata on local brightness, the entry of a so-called summed area table, the result of a so-called prefix sum, which are linked to each raster element.

In order to reduce the data volume and the bandwidth in the case of comparable information content, the apparatus can be designed to replace the raw image data linked to each raster element of the at least one sub-region with the metadata and/or the processed image data. In other words, the amount of data linked to each raster element is reduced by replacing original primary data with a smaller amount of secondary data dependent on the raw image data. For example, the raw image data can be overwritten by the processed image data.

A specific application with which this data overwriting is advantageous arises if at least a subset or partial set of the raw image data of each raster element is representative of a time-dependent measurement signal of a photon counter in each case. In other words, if the raw image data include in each case a time course of a photon count or a photon histogram of a decay curve as fluorescence lifetime data.

The apparatus can then be designed to calculate parameters representative of a fluorescence lifetime using the subset of raw image data of the already read-out sub-region and to replace the subset of raw image data of the already read-out sub-region with these parameters.

Here, suitable parameters are decay coefficients and/or time values. In particular, the method described in European patent application no. 21155585.9 on page 15, line 17 to page 22, line 7 can be used to calculate the parameters. EP 3465156 A1 and EP 3752818 A1 also adequately describe the parameter calculation. For this reason, a more detailed description is not provided here.

Therefore, the raw image data, which represent the time-dependent measurement signal, do not need to be stored permanently, since the calculated parameters represent the fluorescence lifetime sufficiently well. In this embodiment, the apparatus is suitable for use in fluorescence lifetime microscopes.

In addition to the subset mentioned above, the raw image data can also include other information, such as information on the relative and/or absolute spatial position of the raster element to which the raw image data belong. The spatial position of the respective raster element can, for example, be expressed in a simple way by a row index, column index and possibly a depth index.

According to a further possible embodiment of the apparatus, which can easily be used for a confocal laser scanning microscope, the complete raster can be representative of at least one sub-region of a sample volume of a microscope to be scanned. The complete raster is preferably representative of the entire sample volume. The microscope is preferably designed to scan the complete raster, wherein at least a subset of the raw image data is representative of light intensity values measured during scanning. In other words, the microscope is designed to scan the sub-region of the sample volume or the entire sample volume along the complete raster from raster element to raster element. In particular, the microscope can comprise an arrangement consisting of a pinhole aperture and a single photon detector, which are successively directed at predefined scanning points on the microscope. As mentioned above, the raster elements here can represent the scanning points of the microscope.

In a further possible embodiment of the apparatus, which is suitable for an imaging device with an area image sensor comprising a plurality of detector elements, the complete raster can be formed by the detector elements of the area image sensor. The detector elements can be pixels or photodiodes of the area image sensor. The at least one sub-region from which the raw image data are processed can then be formed by a subset of the detector elements. In particular, the sub-region can comprise a contiguous area of the area image sensor. The raster elements are accordingly the detector elements and the raw image data represent the output values of the detector elements.

The apparatus according to embodiments of the invention can also be used in a scanning imaging device that, instead of the arrangement mentioned above of a pinhole aperture and a single photon detector, comprises an area detector with detection elements arranged in a honeycomb pattern, wherein the area detector of the imaging device is designed to be successively directed to the predefined scanning points. Thus, each of the detector elements can take over the function of the pinhole aperture. At the same time, more light is collected on the entire area detector than with a traditional confocal structure with a mechanical pinhole aperture and a single photon detector.

With such a scanning imaging device, it is useful if the complete raster is divided into an upper raster and a lower raster. In particular, each raster element of the complete raster can itself have the lower raster. The upper raster results from the sum of all scanning points, while the respective lower raster represents the sum of all detector elements of the area detector. The apparatus can be designed accordingly to process the raw image data from a changeable region of the lower raster. This region is preferably contiguous and circular, rectangular, square, hexagonal or polygonal. The region can represent individual detector elements of the area detector or the entire area detector.

The object set out at the beginning can also be achieved by a microscope, in particular a digital light imaging microscope, such as a confocal laser scanning microscope, with an apparatus according to one of the preceding embodiments and with a sample volume. Here, the complete raster is representative of at least a sub-region of the sample volume or the entire sample volume. Furthermore, the microscope is designed to scan the complete raster and generate an image of the sub-region or the entire sample volume, built up raster-element-by-raster-element. In other words, the microscope is designed to scan the sub-region or the entire sample volume as the recording region of the microscope. The scanning can include an area scanning and optionally a depth scanning perpendicular to it.

The microscope according to embodiments of the invention benefits from the advantages of the apparatus and is thus characterized by a time-saving operation. For example, a section of the image that has already been built up can be subjected to automatic image processing during the scanning process.

Optionally, the microscope can comprise at least one display screen that is designed to graphically display the processed image data during scanning. For example, the digital partial image mentioned above can appear as a preview on the display screen.

To further save time, the microscope can be designed to scan the recording region block-by-block in order to read out the sub-region, the raw image data of which are to be processed first or next as early as possible. Here, square-by-square or cube-by-cube scanning is preferable to line-by-line scanning so that, for example, it is not necessary to wait for three lines to be completely read out before raw image data from a 3×3 sub-region can be processed. In other words, it is advantageous if, during scanning, a column index and/or a depth index is increased at least once before a row index is run through completely. The row index, column index or depth index can also be lowered in the meantime.

According to another possible embodiment, the microscope can comprise an image sensor having a plurality of detector elements arranged in a lower raster. Structurally, this corresponds to the scanning imaging device mentioned above. The microscope can be designed accordingly to generate, in particular calculate, the raw image data as a function of the measured values of the detector elements by means of the image sensor on each raster element of the complete raster.

In order to fit as many detector elements as possible into a small space, they are preferably designed, built up and/or arranged hexagonally. Alternatively, the image sensor can be a line-by-line readable SCMOS sensor (scientific complementary metal oxide semiconductor sensor) or an active pixel sensor. Instead of an image sensor, the microscope can also comprise an arrangement having a detection pinhole aperture and a single detector, as described above.

Furthermore, the apparatus can be designed to receive the raw image data in the form of a partial image data stream from the image sensor or the individual detector. A deconvolution function, in particular a linear deconvolution function, can be applied to the partial image data stream in the apparatus in order to realize the aforementioned noise suppression.

Optionally, the microscope can comprise an illumination device and the apparatus can be designed to remove an illumination error from the raw image data upon generating the processed image data. For example, the aforementioned filter mask can be adjusted in real time based on the calculated illumination error. Thus, the illumination error can be detected and proactively corrected at an early stage and does not lead to a loss of image quality.

If the illumination error persists despite the correction attempt, the apparatus can be designed to recognize the persistence of the illumination error and abort the scanning process. Optionally, a corresponding error message can appear on the display screen. Thus, wasting time due to completely incorrect recording is prevented.

A microscopy method for scanning a sample volume and generating an image of the sample volume built up raster-element-by-raster-element also achieves the object set out at the beginning. Within the framework of the microscopy method, raw image data representing at least one already scanned sub-region of the sample volume is processed in real time during scanning, processed image data are generated in at least one processing step based on the raw image data and the processed image data are made available for display.

Like the apparatus and the microscope, the microscopy method according to the embodiments of the invention achieves significant time savings by processing the raw image data in parallel with the scanning of the next sub-region.

Optionally, the processed image data can be combined into at least one continuously updated digital partial image of the already scanned sub-region, in order to obtain a preview.

The object set out at the beginning is also achieved by a computer program and/or a computer-readable storage medium. The computer program comprises instructions that, when the computer program is executed by a computer, cause the computer to execute the steps of the above computer-implemented method. Likewise, the computer-readable storage medium comprises instructions that, when executed by a computer, cause the computer to execute the steps of the above computer-implemented method.

The use of an embedded image processor and/or an integrated circuit for executing the steps of the above computer-implemented method also achieves the object set out at the beginning.

The features described above can be used both for the method according to the embodiments of the invention and for the apparatus according to embodiments of the invention, even if this is not explicitly stated. Thus, a method feature that is only explicitly described in the context of the method can also represent an apparatus feature. Conversely, an apparatus feature that is only described in the context of the apparatus can also represent a method feature. Here, an apparatus, an arrangement or a unit can correspond to a method step or a function of a method step. Similarly, aspects that are described within the framework of a method step also represent a description of a corresponding unit, arrangement, device or property thereof. The advantages described in relation to the apparatus also apply to the method according to embodiments of the invention and vice versa.

The term “and/or” can be abbreviated as “/” and includes all combinations of one or more of the associated listed items.

Exemplary embodiments can be based on the use of a machine learning model or machine learning algorithm. Machine learning can refer to algorithms and statistical models that computer systems can use to execute a specific task without using explicit instructions, rather than relying on models and inference. With machine learning, for example, instead of a transformation of data based on rules, a transformation of data that can be derived from an analysis of historical and/or training data can be used. For example, the content of images can be analyzed using a machine learning model or using a machine learning algorithm. So that the machine learning model can analyze the content of an image, the machine learning model can be trained using training images as input and training content information as output. By training the machine learning model with a large number of training images and/or training sequences (for example, words or sentences) and associated training content information (for example, labels or annotations), the machine learning model “learns” to recognize the content of the images, so that the content of images not included in the training data can be recognized using the machine learning model. The same principle can be used for other types of sensor data as well: by training a machine learning model using training sensor data and a desired output, the machine learning model “learns” a transformation between the sensor data and the output, which can be used to provide an output based on non-training sensor data provided to the machine learning model. The data provided (for example, sensor data, metadata and/or image data) can be pre-processed in order to obtain a feature vector, which is used as input for the machine learning model.

Machine learning models can be trained using training input data. The examples cited above use a training method called “supervised learning.” With supervised learning, the machine learning model is trained using a plurality of training sampling values, wherein each sampling value can comprise a plurality of input data values and a plurality of desired output values, i.e., each training sampling value is associated with a desired output value. By specifying both training sampling values and desired output values, the machine learning model “learns” which output value to provide based on an input sampling value that is similar to the sampling values provided during training. In addition to supervised learning, semi-supervised learning can also be used. With semi-supervised learning, some of the training sampling values are missing a desired output value. Supervised learning can be based on a supervised learning algorithm (for example, a classification algorithm, a regression algorithm or a similarity learning algorithm). Classification algorithms can be used if the outputs are restricted to a limited set of values (categorical variables), i.e., the input is classified as one of the limited set of values. Regression algorithms can be used if the outputs show any numerical value (within a range). Similarity learning algorithms can be similar to both classification and regression algorithms, but are based on learning from examples using a similarity function that measures how similar or related two objects are. In addition to supervised learning or semi-supervised learning, unsupervised learning can be used to train the machine learning model. With unsupervised learning, (only) input data can be provided and an unsupervised learning algorithm can be used to find a structure in the input data (for example, by grouping or clustering the input data, finding commonalities in the data). Clustering is the assignment of input data comprising a plurality of input values into partial sets (clusters), so that input values within the same cluster are similar according to one or more (predefined) similarity criteria, while they are dissimilar to input values included in other clusters.

Reinforcement learning is a third group of machine learning algorithms. In other words, reinforcement learning can be used to train the machine learning model. With reinforcement learning, one or more software agents are trained to perform actions in an environment. A reward is calculated based on the actions performed. Reinforcement learning is based on training one or more software agents to select actions such that the cumulative reward is increased, resulting in software agents that become better at the task they are given (as evidenced by increasing rewards).

Furthermore, some techniques can be applied to some of the machine learning algorithms. For example, feature learning can be used. In other words, the machine learning model can be at least partially trained using feature learning, and/or the machine learning algorithm can comprise a feature learning component. Feature learning algorithms, referred to as representation learning algorithms, can receive the information in their input, but transform it so that it becomes useful, often as a pre-processing stage prior to executing the classification or prediction. Feature learning can be based on a principal component analysis or cluster analysis, for example.

With some examples, anomaly detection (i.e., outlier detection) can be used, which aims to provide an identification of input values that raise suspicion since they differ significantly from the majority of input and training data. In other words, the machine learning model can be trained at least in part using anomaly detection, and/or the machine learning algorithm can comprise an anomaly detection component.

With some examples, the machine learning algorithm can use a decision tree as a prediction model. In other words, the machine learning model can be based on a decision tree. With a decision tree, the observations for an item (for example, a set of input values) can be represented by the branches of the decision tree, and an output value corresponding to the item can be represented by the leaves of the decision tree. Decision trees can support both discrete values and continuous values as output values. If discrete values are used, the decision tree can be referred to as a classification tree; if continuous values are used, the decision tree can be referred to as a regression tree.

Association rules are another technique that can be used with machine learning algorithms. In other words, the machine learning model can be based on one or more association rules. Association rules are created by identifying relationships between variables in large amounts of data. The machine learning algorithm can identify and/or utilize one or more ratio rules that represent the knowledge derived from the data. The rules can be used, for example, to store, manipulate or apply the knowledge.

Machine learning algorithms are usually based on a machine learning model. In other words, the term “machine learning algorithm” can refer to a set of instructions that can be used to create, train or use a machine learning model. The term “machine learning model” can refer to a data structure and/or a set of rules representing the learned knowledge (for example, based on the training executed by the machine learning algorithm). With exemplary embodiments, the use of a machine learning algorithm may imply the use of an underlying machine learning model (or a plurality of underlying machine learning models). The use of a machine learning model may imply that the machine learning model and/or the data structure/set of rules that is/are the machine learning model is/are trained by a machine learning algorithm.

For example, the machine learning model can be an artificial neural network (ANN). ANNs are systems inspired by biological neural networks, such as those found in a retina or brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Each node can represent an artificial neuron. Each edge can send information from one node to another. The output of a node can be defined as a (non-linear) function of the inputs (for example, the sum of its inputs). The inputs of a node can be used in the function based on a “weight” of the edge or node providing the input. The weight of nodes and/or edges can be adjusted in the learning process. In other words, training an artificial neural network can comprise adjusting the weights of the nodes and/or edges of the artificial neural network, i.e., to achieve a desired output for a given input.

Alternatively, the machine learning model can be a support vector machine, a random forest model or a gradient boosting model. Support vector machines (i.e., support vector networks) are supervised learning models with associated learning algorithms that can be used to analyze data (for example, in a classification or regression analysis). Support vector machines can be trained by providing an input with a plurality of training input values belonging to one of two categories. The support vector machine can be trained to assign a new input value to one of the two categories. Alternatively, the machine learning model can be a Bayesian network, which is a probabilistic directed acyclic graphical model. A Bayesian network can represent a set of random variables and their conditional dependencies using a directed acyclic graph. Alternatively, the machine learning model can be based on a genetic algorithm, which is a search algorithm and heuristic technique that mimics the process of natural selection.

Embodiments of the invention are explained in more detail below with reference to the drawings. The combination of features shown by way of example in the embodiments shown can, in accordance with the above explanations, be supplemented by further features depending on the properties of the apparatus according to embodiments of the invention and/or the microscope according to embodiments of the invention and/or the method according to embodiments of the invention required for a specific application. Also, according to the above explanations, individual features can also be omitted in the described embodiments if the effect of this feature is not relevant in a specific application. In the drawings, the same reference signs are always used for elements having the same function and/or structure.

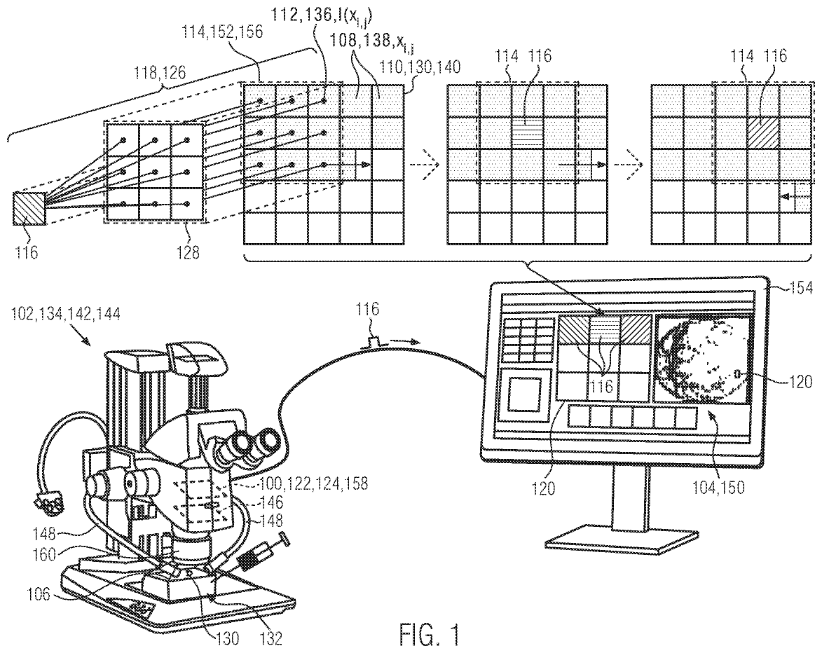

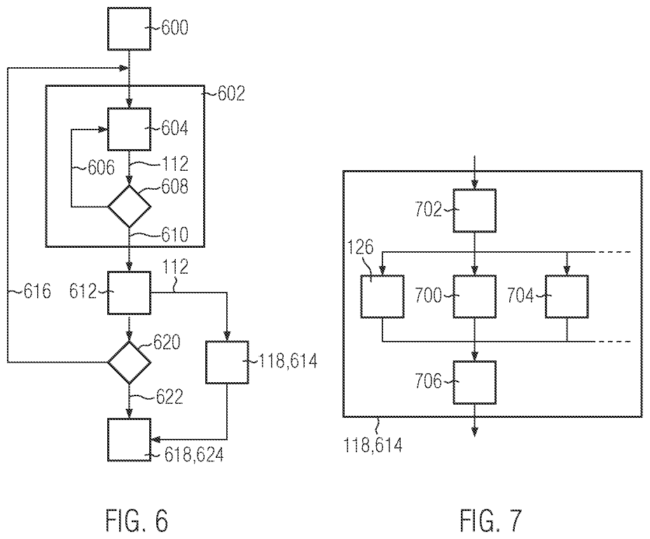

In the following, the structure and function of an apparatus 100 according to embodiments of the invention and of a microscope 134 according to embodiments of the invention are described by way of example with reference to FIGS. 1 to 5 and 9. Furthermore, the method according to embodiments of the invention is explained with reference to FIGS. 6 to 8. Although some aspects of the invention are only described within the framework of the apparatus 100, it is of course possible that these aspects also constitute a description of the corresponding method, wherein, for example, a block, a module, a unit, a device or a feature of the apparatus 100 corresponds to a method step or a function of a method step. Similarly, aspects that are described within the framework of a method step also correspondingly represent a description of a block, a module, a unit, a device or a property of the apparatus 100.

FIG. 1 shows a simplified, schematic representation of a digital imaging device 102 having an exemplary embodiment of the apparatus 100. The apparatus 100 is used for data processing in the imaging device 102. The imaging device 102 is designed to generate a digital image 104 of a recording region 106 by reading out a multi-dimensional complete raster 110, including a plurality of raster elements 108, raster-element-by-raster-element. Here, the image 104 of the recording region 106 represents a complete image 150. To generate the complete image 150, all raster elements 108 of the complete raster 110 are exposed and read out.

During exposure and reading out, raw image data 112 in the form of, for example, monochrome brightness values, RGB values or a histogram of a decay curve are linked to each raster element 108 of the complete raster 110. Here, the raw image data 112 can be arranged in a two-dimensional or three-dimensional matrix 152. Preferably, the raw image data 112 are stored in an N-dimensional array I(xᵢ) where N is an integer greater than 2.

Here, the expression x; is an abbreviated notation of a tuple {x₁; . . . ; x_{N}} which includes N location values. Thus, x; represents a discrete position in the array I(xᵢ) with the coordinates {x₁; . . . ; x_{N}} or the location vector to this position. The position xᵢ designates, for example, a pair of discrete location variables {x₁; x₂} in the case of two-dimensional raw image data 112 and a triplet of discrete location variables {x₁; x₂; x₃} in the case of three-dimensional raw image data 112. Here, the subscript number represents a row index. If available, a second subscript number stands for a column index and a third subscript number for a depth index.

Since no reference to a specific location or dimension is necessary in the following, the location is generally designated with xᵢ and the dimension with i. The position xᵢ can be represented by a single pixel 400 or a coherent group of pixels 400 in the raw image data 112.

In the i-th dimension, the array/(xᵢ) can include Mᵢ digits, i.e, xᵢ={x_{i,1}, . . . , x_{i,M}_{ᵢ}} In total, the array I(xᵢ) can consequently include M₁× . . . ×M_{N} elements.

I(xᵢ) can be any value or a combination of values at the position xᵢ for example, a value that represents the intensity of a color or a channel in a color space, for example the intensity of the color R in the RGB color space, or a combined intensity of more than one color, for example

$$\frac{R + G + B}{3}$$

in the RGB color space. Raw image data 112 recorded by a multispectral or hyperspectral imaging device 102 can include more than three channels. Each channel can represent a different spectrum or a different spectral range of the light spectrum. For example, more than three channels can be used in order to represent the spectrum of visible light.

For example, two-dimensional raw image data 112 available in three-color RGB format can be considered as three related sets or groups of two-dimensional raw image data 112 I(x)={I_{R}(xᵢ); I_{G}(xᵢ); I_{B}(xᵢ)}, where I_{R}(xᵢ) represents a value, such as the intensity of the color, R, I_{G}(xᵢ) represents a value, such as the intensity of the color G, and I_{B}(xᵢ) represents a value, such as the intensity of the color B. Alternatively, each color can be considered to form separate raw image data 112, i.e., I_{R}(xᵢ), I_{G}(xᵢ) and I_{B}(xᵢ).

The raw image data 112 can also include other information, such as information regarding the relative and/or absolute spatial location of the raster element 108 to which the raw image data 112 in each case belong. Here, in each case the spatial position of the respective raster element 112 can be expressed by the row index, column index and, if applicable, depth index of the matrix 152.

The imaging device 102 in each of FIGS. 1 to 3 is a microscope 134, in particular a digital light imaging microscope 142, such as a confocal laser scanning microscope 144, for which the apparatus 100 can be designed.

In the recording region 106, the microscope 134 has a sample volume 132 in which an object 200 or specimen 202 can be arranged. In the microscopy method according to embodiments of the invention, this object 200 or specimen 202 can be prepared and arranged in the sample volume 132 (see step 600 in FIG. 6).

The complete raster 110 can be representative of at least a sub-region 130 of the sample volume 132 or the entire sample volume 132. To examine the object 200 or specimen 202, the microscope 134 can be designed to scan the complete raster 110 and thereby build up the digital image 104 of the sub-region 130 or the entire specimen volume 132 raster-element-by-raster-element (see steps 602 to 624 in FIG. 6).

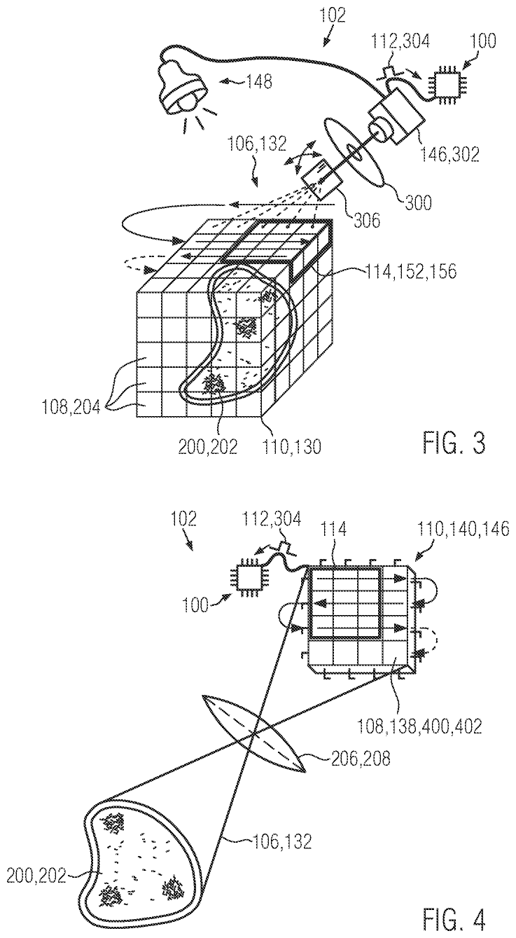

Scanning can include an area scan and optionally a perpendicular depth scan. Here, each scanning point 204 of the microscope 134 represents a raster element 108 of the complete raster 110. As a function thereof, the complete raster 110 can be two dimensional (see FIG. 1) or three-dimensional (FIG. 3).

In other words, the microscope 134 is designed to scan the sub-region 130 of the sample volume 132 or the entire sample volume 132 along the complete raster 110 from raster element 108 to raster element 108. For this purpose, the microscope 134 shown in FIG. 3 comprises an arrangement consisting of a pinhole aperture 300 and a single photon detector 302, which are successively directed at predefined scanning points 204 of the microscope 134. At least a subset of the raw image data 112 is representative of light intensity values 304 measured by the photon detector 302.

If the object 200 includes fluorescent materials, such as at least one fluorophore or at least one autofluorescent substance, each of the channels mentioned above can represent a different fluorescent spectrum. For example, if a plurality of fluorophores are present in the object 200, each fluorescence spectrum of a fluorophore can be represented by a different channel of the raw image data 112. Different channels can, on the one hand, be used for fluorescence, which is selectively triggered by illumination, and, on the other hand, for autofluorescence, which is generated as a byproduct or as a secondary effect of the triggered fluorescence. Further channels can cover the near-infrared and infrared ranges. A channel need not necessarily include intensity data, but can also represent other types of data related to the image 104 of the object 200. For example, a channel can include fluorescence lifetime data representative of the fluorescence lifetime after triggering at a particular location x; in the image 104. In general, the raw image data 112 can therefore take the following form:

$$I ( {x}_{i} ) = \{ {I}_{1} ( {x}_{i} ) ; {I}_{2} ( {x}_{i} ) ; … ; {I}_{C} ( {x}_{i} ) \}$$

where C is the total number of channels in the raw image data 112.

The imaging device 102 shown in FIG. 4 comprises an area image sensor 140 comprising a plurality of detector elements 138. The detector elements 138 can be pixels 400 or photodiodes 402 of the area image sensor 140. The recording region 106, in which the object 200 or specimen 202 is located, is not scanned here, but is instead illuminated globally. Nevertheless, the detector elements 138 are successively read out. Here, the complete raster 110 is formed by the totality of all detector elements 138 of the area image sensor 140, wherein each detector element 138 represents a raster element 108.

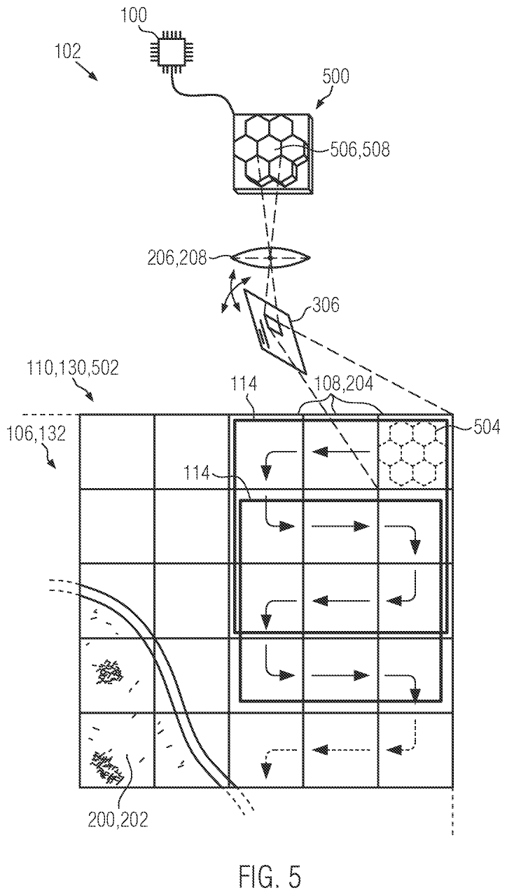

In FIG. 5, the apparatus 100 is shown in a scanning imaging device 102, which comprises an area detector 500 with detector elements 138 arranged in a honeycomb pattern instead of the arrangement mentioned above consisting of a pinhole aperture 300 and a single photon detector 302. The area detector 500 is designed to be successively directed to the predefined scanning points 204 via a mirror mechanism 306.

In view of this device structure, the complete raster 110 shown in FIG. 5 can be divided into an upper raster 502 and a lower raster 504. The upper raster 502 results from the sum of all scanning points 204, while the respective lower raster 504 represents the sum of all detector elements 138 of the area detector 500. Consequently, the lower raster 504 is repeated in each raster element 108 of the complete raster 110, since the area detector 500 is directed to each scanning point 204 in turn.

As explained above, the complete raster 110 can be a physical entity that is present as a tangible part of a technical device (for example, the totality of all detector elements 138 of the area image sensor 140). The complete raster 110 can also be a virtual structure that is predefined in the form of a user specification by information technology control and regulation commands (for example, totality of all scanning points 204). The same applies to the upper raster 502, the lower raster 504 and the raster elements 108. According to embodiments of the invention, raw image data 112 are processed from already read-out raster elements 108 during the read-out of the complete raster 110, can be applied to both the physical and the virtual case.

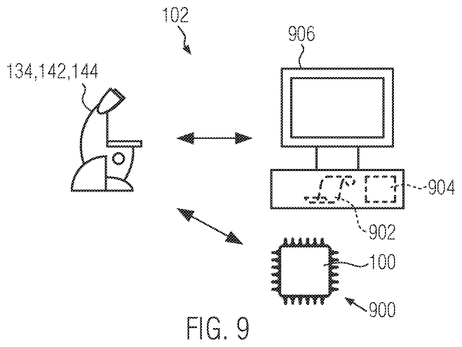

The apparatus 100 is part of a control unit 158 installed in the imaging device 102. Alternatively, the apparatus 100 can be designed to be controllable by the control unit 158. With the microscope 134 shown in FIG. 1, the control unit 158 can be designed to control movable elements, such as objectives 206, lenses 208, adjustment mimics 210, a microscope stage 212 or attachment 160 of the microscope 134. In particular, the apparatus can comprise at least one image processor 122 and/or integrated circuit 124, in particular a field programmable gate array (FPGA), embedded in the imaging device 102. As an alternative to a complete structural integration of the apparatus 100 into the imaging device 102, the apparatus 100 can also be operated as a component 900 external to the imaging device 102 (see FIG. 9).

The apparatus 100 is designed to process the aforementioned raw image data 112 from at least one already read-out sub-region 114 of the complete raster 110 during the read-out of the remaining sub-regions of the complete raster 110 (see step 602 in FIG. 6). The processing of the raw image data 112 includes, in particular, obtaining, reading out, retrieving, querying or receiving the raw image data 112 from the at least one already read-out sub-region 114 of the complete raster 110 (see step 702 in FIG. 7). In particular, the apparatus 100 can be designed to process the raw image data 112 before the complete raster 110 is completely read out (see step 614 in FIG. 6).

The complete raster 110 includes a plurality of sub-regions 114, which can also overlap with one another (see FIG. 5). According to the dimension of the complete raster 110, each sub-region 114 can represent a two-dimensional or three-dimensional array 156 of data of predetermined size. Here, the size of each sub-region 114 can be constant or variable. Thus, each sub-region 114 includes a plurality of raster elements 108 in a constant or variable number. The raw image data 112 are processed as soon as all raster elements 108 of the current sub-region 114 have been completely read out.

With the imaging device of FIG. 4, the at least one sub-region 114, the raw image data 112 of which are processed, can be formed by a subset 506 of the detector elements 138. In particular, the sub-region 114 can comprise a contiguous area of the area image sensor 140. Accordingly, the raw image data 112 represent the output values of the detector elements 138.

The apparatus 100 in the imaging device 102 of FIG. 5 can be designed accordingly to process the raw image data 112 from a changeable region 508 of the lower raster 504. This region 508 is preferably contiguous. Thus, the region 508 can alternately include only individual detector elements 138 of the area detector 500, for example the center detector element 138, and the entire area detector 500. If the region 508 comprises the central detector element 138, this assumes the function of the pinhole aperture 300. If the region 508 comprises the entire area detector 500, more light can be collected than in a traditional confocal structure with a mechanical pinhole aperture and a single photon detector.

Upon reading out raster-element-by-raster-element, the individual raster elements 108 are read out separately from one another in terms of time and/or location, for example, pixel-by-pixel, voxel-by-voxel, line-by-line or plane-by-plane. However, the raster elements 108 can also be read out block-by-block in order to finish reading out the sub-region 114, the raw image data 112 of which is to be processed first or next, as early as possible. Here, a square-by-square or cube-by-cube reading out is preferred so that, for example, it is not necessary to wait for three lines to be completely read out before raw image data 112 from a 3×3 sub-region 114 can be processed. In other words, it is advantageous if, during reading out, a row index and/or a depth index of the matrix 152 is increased at least once before a column index of the matrix 152 is run through completely. For example, the complete raster 110 can be read out in a meandering manner (see FIG. 5). The row index, column index and/or depth index of the matrix 152 can also be lowered in the meantime.

In addition, the apparatus 100 is designed to generate processed image data 116 in at least one processing step 118 as a function of the raw image data 112 (see FIG. 7). Here, the at least one processing step 118 can be executed in the embedded image processor 122 and/or integrated circuit 124.

As shown in FIG. 7, the at least one processing step 118 can comprise filtering 126 of the raw image data 112 of the at least one already read-out sub-region 114 with a filter mask 128. Such filtering 126 can comprise, for example, a low-pass filter, a high-pass filter, a band-pass filter or a combination of these filters. The filtering 126 can be effected analytically or iteratively using known calculation rules or based on machine learning or artificial intelligence.

FIG. 1 shows an example of a two-dimensional filter mask 128 having a 3×3 format. Accordingly, at least one sub-region 114 also has the format 3×3. Here, the 3×3 format describes the fact that both the filter mask 128 and the sub-region 114 are three raster elements 108 high and three raster elements 108 wide.

I(\vec{x}) is the above-mentioned matrix 152 with intensity values as raw image data 112 from the sub-region 114:

$$I ( \vec{x} ) = [ \begin{matrix}I ( {x}_{1 , 1} ) & I ( {x}_{1 , 2} ) & I ( {x}_{1 , 3} ) \\ I ( {x}_{2 , 1} ) & I ( {x}_{2 , 2} ) & I ( {x}_{2 , 3} ) \\ I ( {x}_{3 , 1} ) & I ( {x}_{3 , 2} ) & I ( {x}_{3 , 3} )\end{matrix} ]$$

A filter matrix F with constant filter coefficients f_{i,j} is:

$$F = [ \begin{matrix}{f}_{1 , 1} & {f}_{1 , 2} & {f}_{1 , 3} \\ {f}_{2 , 1} & {f}_{2 , 2} & {f}_{2 , 3} \\ {f}_{3 , 1} & {f}_{3 , 2} & {f}_{3 , 3}\end{matrix} ]$$

The filter result for the raster element in the line i and the column j can result from the following general calculation rule:

$${R}_{i , j} = {\sum }_{k = i - 1}^{k = i + 1} [ {\sum }_{l = j - 1}^{l = j + 1} {f}_{k , l} \cdot I ( {x}_{k , l} ) ]$$

For example, for the raster element in the second row (i=2) of the second column (j=2):

$${R}_{2 , 2} = {f}_{1 , 1} \cdot I ( {x}_{1 , 1} ) + {f}_{1 , 2} \cdot I ( {x}_{1 , 2} ) + {f}_{1 , 3} \cdot I ( {x}_{1 , 3} ) + {f}_{2 , 1} \cdot I ( {x}_{2 , 1} ) + {f}_{2 , 2} \cdot I ( {x}_{2 , 2} ) + {f}_{2 , 3} \cdot I ( {x}_{2 , 3} ) + {f}_{3 , 1} \cdot I ( {x}_{3 , 1} ) + {f}_{3 , 2} \cdot I ( {x}_{3 , 2} ) + {f}_{3 , 3} \cdot I ( {x}_{3 , 3} )$$

This filter result can be entered in the second row of the second column of a matrix B(\vec{x}) of the processed image data 116:

$$B ( \vec{x} ) = [ \begin{matrix}{R}_{1 , 1} & {R}_{1 , 2} & {R}_{1 , 3} \\ {R}_{2 , 1} & {R}_{2 , 2} & {R}_{2 , 3} \\ {R}_{3 , 1} & {R}_{3 , 2} & {R}_{3 , 3}\end{matrix} ]$$

Alternatively, the format of the filter mask 128 and the sub-region 114 can also be 1×3, 4×4 or 5×5, for example. For a three-dimensional complete raster 110, the filter mask 128 and the sub-region 114 can in each case have the format 3×3×3, 1×1×3, 4×4×4 or 5×5×5. Furthermore, the filter mask can be designed to be cross-shaped or approximately circular or spherical (not shown). The calculation rule for the filter result can be extended analogously for the three-dimensional case.

The matrix coefficients f_{i,j} of the filter matrix F do not have to be constant. For example, the matrix coefficients f_{i,j} can be variable depending on the raw image data 112 still to be filtered. In this way, a signal-to-noise ratio, in particular a local signal-to-noise ratio, can be calculated from the raw image data 112 in advance of the filtering and included in a calculation of the matrix coefficients f_{i,j}.

In addition, the apparatus 100 can be designed to update the filter mask 128 as a function of the already filtered raw image data 112. In particular, the signal-to-noise ratio can be calculated from the processed image data 116. In particular, the change in the signal-to-noise ratio before and after filtering allows qualitative and quantitative conclusions to be drawn about the matrix coefficients f_{i,j}.

Furthermore, the apparatus 100 can be designed to update the filter mask 128 as a function of the position and/or geometry of the already read-out sub-region 114. For example, a different filter mask 128 than in the core of the complete raster 110 can be used near the edge of the complete raster 110. Similarly, in the case of a three-dimensional complete raster 110 that is read out plane-by-plane, the filter mask 128 used can initially be two-dimensional as long as only raster elements 108 from the same plane have been read out. As soon as a plurality of planes have been at least partially read out, the filter mask 128 can be expanded three-dimensionally.

Updating the filter mask 128 can be effected in real time and/or by obtaining, reading out, receiving an adjusted filter mask 128. In particular, an adaptive filter mask, which is updated using a process based on machine learning or artificial intelligence, can be used here. Preferably, the filter mask 128 is updated sub-region-by-sub-region, i.e., from sub-region 114 to sub-region 114.

All methods described within the framework of this application, such as filtering 126 (see above) or the noise suppression 700 explained below, can also be implemented based on machine learning or artificial intelligence.

Alternatively or additionally, the at least one processing step 118 can comprise noise suppression 700 (see FIG. 7). As will be explained below, the noise suppression 700 can be effected, for example, by deconvolution or inversion of a convolution operation on the raw image data 112.

With noise suppression 700, it is assumed that the raw image data 112 results from a convolution of the actual image Iₜᵣᵤₑ(xᵢ) with a usually device-specific point spread function psf and a noise term n that is additive thereto:

$$I ( {x}_{i} ) = {I}_{true} ( {x}_{i} ) * psf + n$$

This equation can be solved iteratively, for example with the so-called Richardson-Lucy algorithm, in order to obtain an approximation of the actual image Iₜᵣᵤₑ(xᵢ).

Further, the apparatus 100 can be designed to carry out additional processing steps 118 to improve the image quality of the image 104. If, for example, a two-dimensional image 104 of a three-dimensional area is recorded using an imaging device, only that which lies within the focal range of the imaging device is sharply depicted. Everything that is not within the focus area is depicted as blurred. This out-of-focus contribution to the image leads to image errors that standard imaging devices and methods for generating image sharpness, such as by means of the deconvolution explained above, cannot remove.

In this connection, it can be assumed that portions in focus have a high spatial frequency and are responsible, for example, for intensity and/or color changes that occur over a short distance in the raw image data 112. The out-of-focus portions are assumed to have a low spatial frequency; i.e., they lead to a predominantly gradual intensity and/or color changes that extend over large regions of the raw image data 112.

Based on this assumption, the intensity and/or color changes over the raw image data 112 can be additively decomposed into an in-focus portion with high spatial frequency I₁(xᵢ) and an out-of-focus portion with low spatial frequency I₂(xᵢ) as follows:

$$I ( {x}_{i} ) = {I}_{1} ( {x}_{i} ) + {I}_{2} ( {x}_{i} ) .$$

Due to the low spatial frequency of the out-of-focus portion I₂(xᵢ), it can be considered as a more or less smooth baseline, which superimposes the in-focus components as objects with a high spatial frequency. The apparatus 100 can be designed to estimate this baseline by applying a fit to the raw image data 112. Mathematically, the fit, i.e., the baseline estimation, is represented by discrete baseline estimation data f(xᵢ). The baseline estimation data f(xᵢ) can also be an array with N dimensions and M₁× . . . ×M_{N} elements and can therefore have the same dimensionality as the raw image data 112.

To calculate the baseline estimation data, a squared error minimization criterion can be applied, which can be minimized for the fit. In a specific case, the fit can be a polynomial fit to the raw image data. In particular, the baseline estimation data can be represented by a polynomial of order K in each of the N dimensions i:

$$f ( {x}_{i} ) = {\sum }_{k = 0}^{K} {a}_{i , k} {x}_{i}^{k} = {a}_{i , 0} + {a}_{i , 1} {x}_{i}^{1} + {a}_{i , 2} {x}_{i}^{2} + … + {a}_{i , K} {x}_{i}^{K} ,$$

where a_{i,k} are the coefficients of the polynomial in the i-th dimension. For each dimension i=1, . . . , N, a separate polynomial can be calculated. Alternatively, a spline fit can also be used.

As soon as the baseline estimation data have been determined and thus a baseline estimation f(xᵢ) for I₂(xᵢ) has been obtained, the blur-reduced, processed image data B(xᵢ) can be calculated by subtracting the baseline estimation f(xᵢ) from the raw image data I(xᵢ):

$$B ( {x}_{i} ) = I ( {x}_{i} ) - f ( {x}_{i} ) .$$

The processed image data are preferably also represented by a discrete array with dimension N and M₁× . . . ×M_{N} elements and therefore preferably have the same dimensionality as the raw image data and/or the baseline estimation data.

The exact formulation of the squared error minimization criterion determines the properties of the fit and thus of the baseline estimation data. An inappropriate selection of the squared error minimization criterion can result in the baseline estimation not representing the out-of-focus portions with sufficient accuracy. According to one embodiment, the squared error minimization criterion M (f(xᵢ)) can have the following form:

$$M ( f ( {x}_{i} ) ) = C ( f ( {x}_{i} ) ) + P ( f ( {x}_{i} ) ) ,$$

where C(f(xᵢ)) is a cost function and P(f(xᵢ)) is the penalty term. The squared error minimization criterion, the cost function and the penalty term are preferably scalar values.

In a specific case, the cost function represents the difference between the raw image data I(xᵢ) and the baseline estimation data f(xᵢ). For example, if ε(xᵢ) represents the difference term between the raw image data and the baseline estimation data in the form

$$ε ( {x}_{i} ) = I ( {x}_{i} ) - f ( {x}_{i} ) ,$$

the cost function C(f(xᵢ)) can comprise the L2 norm ∥ε(xᵢ)∥², which is used herein as an abbreviated notation of the sum of the root mean squares' values over all dimensions of the sum of the squared differences between the raw image data and the baseline estimation data in the i-th dimension, that is

$${‖ ε ( {x}_{i} ) ‖}^{2} = {\sum }_{i = 1}^{N} {\sum }_{m = 1}^{{M}_{i}} {( I ( {x}_{i , m} ) - f ( {x}_{i , m} ) )}^{2} .$$

The L2 norm ∥ε(xᵢ)∥² is a scalar value. An example of a cost function is:

$$C ( f ( {x}_{i} ) ) = {‖ ε ( {x}_{i} ) ‖}^{2}$$

To improve the accuracy of the baseline estimation, it can be advantageous if the difference between the raw image data and the baseline estimation is truncated or limited, for example by using a truncated difference term. A truncated difference term reduces the effect of peaks in the raw image data on the baseline estimation data. Such a reduction is advantageous if it can be assumed that the in-focus portion is in the peaks I(xᵢ). Due to the truncated difference term, peaks in the raw image data that differ from the baseline estimation by more than a predetermined constant threshold value s are “ignored” in the cost function by limiting their penalty on the fit, in particular the spline fit, to the threshold value. Therefore, the baseline estimation data follow such peaks only up to a limited amount. The truncated quadratic expression can be symmetrical or asymmetrical. The truncated difference term is designated below as φ(ε(xᵢ)).

In some applications, the portions in focus can be located only or at least primarily in the peak values of the raw image data, i.e., in the bright spots of an image. This may be reflected by selecting a truncated or limited quadratic term that is asymmetric and allows the fit to follow only valleys but not peaks in the raw image data. For example, the asymmetric truncated quadratic term φ(ε(xᵢ)) can be of the form

$$φ ( ε ( {x}_{i} ) ) = \{ \begin{matrix}{ε ( {x}_{i} )}^{2} if ε ( {x}_{i} ) \leq s \\ {s}^{2} otherwise\end{matrix} .$$

If, in a further specific application, valleys, i.e., dark regions in the raw image data, are also considered to be in-focus portions, a symmetrically truncated quadratic term can be used instead of the asymmetrically truncated quadratic term. For example, the symmetric truncated quadratic term can have the following form:

$$φ ( ε ( {x}_{i} ) ) = \{ \begin{matrix}{ε ( {x}_{i} )}^{2} if \vert ε ( {x}_{i} ) \vert \leq s \\ {s}^{2} otherwise\end{matrix} .$$

Using a truncated quadratic form, the cost function C(f(xᵢ)) can preferably be expressed as

$$C ( f ( {x}_{i} ) ) = {{\sum }^{N}}_{i = 1} {{\sum }^{{M}_{i}}}_{m = 1} φ ( {x}_{i , m} )$$

The penalty term P(f(xᵢ)) in the squared error minimization criterion M (f(xᵢ)) can take any form that introduces a penalty if the baseline estimation is adjusted to data considered to belong to the in-focus portion I₁(xᵢ). A penalty is generated by the penalty term increasing in value if the in-focus portion of the raw image data is represented in the baseline estimation data.

For example, if it is assumed that the out-of-focus portion I₂(xᵢ) has a low spatial frequency, the penalty term can be a term that becomes large if the spatial frequency of the baseline estimation becomes large.

In one embodiment, such a penalty term can be a roughness penalty term that penalizes non-smooth baseline estimation data that deviate from a smooth baseline. Such a roughness penalty term effectively penalizes the approximation of baseline estimation data to data that have a high spatial frequency.

For example, the roughness penalty term can include a first spatial derivative of the baseline estimation data, in particular the square and/or the absolute value of the first spatial derivative, and/or a second derivative of the baseline estimation data, in particular the square and/or the absolute value of the second spatial derivative. In general, the penalty term can include a spatial derivative of any order of the baseline estimation data or a linear combination of spatial derivatives of the baseline estimation data. Different penalty terms can be used in different dimensions.

For example, the roughness penalty term P(f(xᵢ)) can be formed as follows:

$$P ( f ( {x}_{i} ) ) = {\sum }_{j = 1}^{N} {γ}_{j} {\sum }_{i = 1}^{N} {\sum }_{m = 1}^{{M}_{i}} {( {\partial }_{j}^{2} f ( {x}_{i , m} ) )}^{2} .$$

This roughness penalty penalizes a large rate of change of the gradient of the baseline estimation or equivalently a high curvature and thus favors smooth estimations. Thereby, γⱼ is a control parameter and ∂ⱼ² is a discrete operator for calculating the second derivative in the jth dimension. In the discrete case, the differentiation can be carried out efficiently using a convolution. For example,

$${\partial }_{j}^{2} f ( {x}_{i , m} ) = {D}_{i , m}^{( j )} * f ( {x}_{i , m} )$$

with a derivative matrix of the second order

$${D}_{i , m}^{( j )} = \{ \begin{matrix}1 if m = 1 , {M}_{j} and i = j \\ - 2 if m = 0 and i = j \\ 0 otherwise\end{matrix} .$$

The regulation parameter γⱼ represents spatial length scales of the information in the focused image portion I₁(xᵢ). The regulation parameter γⱼ can be predetermined by a user and is preferably greater than zero. The regulation parameter γⱼ can assume a constant value to save computing time or, to increase accuracy, can be a function locally of the structure of the image. The unit of the regulation parameter γⱼ is selected so that the penalty term is a dimensionless variable. Typically, the regulation parameter has values between 0.3 and 100.

The squared error minimization criterion M(f(xᵢ)) arising from cost function C(f(xᵢ)) and penalty term P(f(xᵢ)) can be minimized using known methods. In one case, a preferably iterative semi-quadratic minimization scheme can be used. To execute the semi-quadratic minimization scheme, the apparatus 100 can comprise a semi-quadratic minimization unit or semi-quadratic minimization processing unit. The semi-quadratic minimization can comprise an iteration algorithm having two iteration stages.

For example, the semi-quadratic minimization scheme can at least partially comprise the so-called LEGEND algorithm, which is computationally efficient. The LEGEND algorithm is described in Idier, J. (2001): Convex Half-Quadratic Criteria and Interacting Variables for Image Restoration, IEEE Transactions on Image Processing, 10(7), S. 1001-1009, and in Mazet, V., Carteret, C., Bire, D., Idier, J., and Humbert, B. (2005): Background Removal from Spectra by Designing and Minimizing a Non-Quadratic Cost Function, Chemometrics and Intelligent Laboratory Systems, 76, pp. 121-133. Both articles are hereby incorporated by reference in their entirety.

For the LEGEND algorithm, discrete auxiliary data d(xᵢ) are introduced, which are preferably of the same dimensionality as the raw image data. The auxiliary data are updated at each iteration depending on the baseline estimation data, the truncated quadratic term and the raw image data.

In the LEGEND algorithm, the squared error minimization criterion is minimized using two iterative steps (henceforth first and second iteration step) until a convergence criterion is met. The convergence criterion can be expressed as:

$$\frac{{\sum }_{i = 0}^{N} {\sum }_{m = 0}^{{M}_{i}} \vert {f}_{l} ( {x}_{i , m} ) - {f}_{l - 1} ( {x}_{i , m} ) \vert}{{\sum }_{i = 0}^{N} {\sum }_{m = 0}^{{M}_{i}} {f}_{l} ( {x}_{i , m} ) + {f}_{l - 1} ( {x}_{i , m} )} < t$$

wherein l and l−1 in each case stand for the current and the previous iteration step and t is a scalar convergence value that can be defined by the user.

As an initial step in the LEGEND algorithm, starting values are defined for the baseline estimation data.

The LEGEND algorithm can be started by selecting the starting values from guessed coefficients aₖ for an initial baseline estimation f₀(xᵢ)=Eₖ₌₀^{K}a_{i,k}xᵢ^{k} for each of the i=1, . . . , N dimensions if a polynomial fit is used.

In the first iteration step, the auxiliary data can be updated as follows:

$${d}_{l} ( {x}_{i} ) = \{ \begin{matrix}( 2 α - 1 ) ( I ( {x}_{i} ) - {f}_{l - 1} ( {x}_{i} ) ) if ε ( {x}_{i} ) \leq s \\ - I ( {x}_{i} ) + {f}_{l - 1} ( {x}_{i} ) otherwise\end{matrix} ,$$

where l=1 . . . L is the index of the current iteration and α is a constant that can be selected by the user. Preferably, α is approximate to, but not equal to 0.5. A suitable value for a is 0.493.

If a spline fit is used, the initial condition at the beginning of the LEGEND algorithm can be d(xᵢ)=0, f(xᵢ)=I(xᵢ) and the iteration is started when the second iterative step is entered.

In the second iteration step, the baseline estimation data f(xᵢ) is updated on the basis of the previously calculated auxiliary data dₗ(xᵢ), the baseline estimation data fₗ₋₁(xᵢ) from the previous iteration l−1 and the penalty term P(xᵢ). In particular, the updated baseline estimation data can be calculated using the following formula in the second iteration step:

$${f}_{l} ( {x}_{i} ) = {argmin}_{f} [ {‖ I ( {x}_{i} ) - {f}_{l - 1} ( {x}_{i} ) + {d}_{l} ( {x}_{i} ) ‖}^{2} + P ( f ( {x}_{i} ) ) ] .$$

Here, [∥I(xᵢ)−fₗ₋₁(xᵢ)+dₗ(xᵢ)∥²+P(f(xᵢ)] represents a half-quadratic minimization criterion that is modified for the LEGEND algorithm by including the auxiliary data d(xᵢ).

Specifically, in the second iteration step, the baseline estimation data can be updated using the following matrix calculation:

$${f}_{l} ( {x}_{i} ) = {( 1 + {\sum }_{i = 1}^{N} {γ}_{i} {A}_{i}^{T} {A}_{i} )}^{- 1} ( I ( {x}_{i} ) + d ( {x}_{i} ) ) ) .$$

Where (1+Σᵢ₌₁^{N}γᵢAᵢ^{T}Aᵢ) is an (M₁× . . . ×M_{N})² dimensional array. In the two-dimensional case, Aᵢ is an (Mₓ−1)(M_{y}−1)×MₓM_{y} array and is given as

$${A}_{i} = ( \begin{matrix}\hat{A} & - \hat{A} & \hat{0} & … & \hat{0} \\ \hat{0} & \hat{A} & - \hat{A} & ⋱ & ⋮ \\ ⋮ & ⋱ & ⋱ & ⋱ & \hat{0} \\ \hat{0} & … & \hat{0} & \hat{A} & - \hat{A}\end{matrix} )$$

$$where$$

$$\hat{A} = ( \begin{matrix}1 & - 1 & 0 & … & 0 \\ 0 & 1 & - 1 & ⋱ & ⋮ \\ ⋮ & ⋱ & ⋱ & ⋱ & 0 \\ 0 & … & 0 & 1 & - 1\end{matrix} ) , \hat{0} = ( \begin{matrix}0 & 0 & 0 & … & 0 \\ 0 & 0 & 0 & ⋱ & ⋮ \\ ⋮ & ⋱ & ⋱ & ⋱ & 0 \\ 0 & … & 0 & 0 & 0\end{matrix} ) ∈ {ℝ}^{( {M}_{x} - 1 ) \times {M}_{x}} .$$

The two iteration steps for updating dₗ(xᵢ) and fₗ(xᵢ) are repeated until the convergence criterion mentioned above is fulfilled.

For further calculation options for the baseline estimation data, reference is made to page 5, line 18 to page 14, line 15 of DE 202018006284 U1. EP 117241 B1, EP 3588430 A1, EP 3588432 A1 and EP 3716199 A1 also deal with the calculation of baseline estimation data.

Optionally, the apparatus 100 can be designed to assign metadata 800 to the at least one sub-region 114, which metadata 800 are calculated as a function of raw image data 112 associated with each raster element 108 of the at least one sub-region 114. Further, the apparatus 100 can be designed to replace the raw image data 112 associated with each raster element 108 of the at least one sub-region 114 with the metadata 800 and/or the processed image data 116.

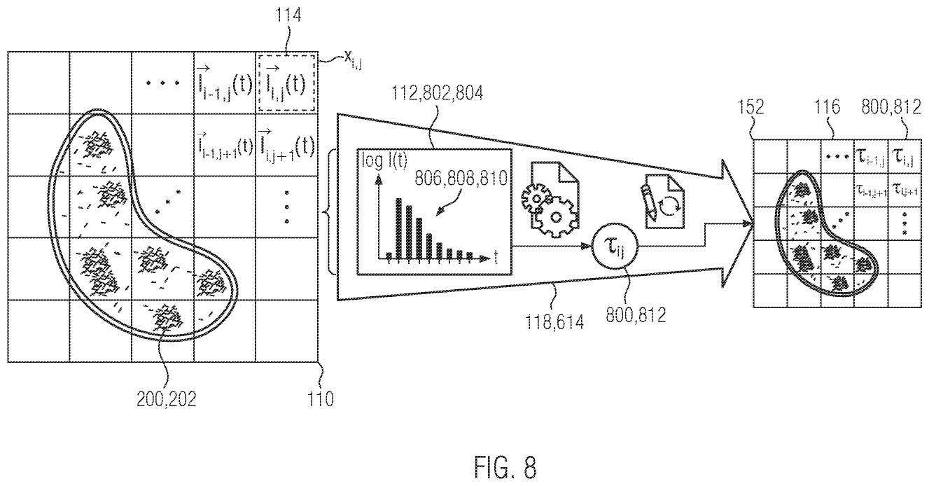

For example, the raw image data 112 can be overwritten by the processed image data 116, as indicated in FIG. 8. There, a subset 802 or partial set 804 of the raw image data 112 of each raster element 108 in each case is representative of a respective time-dependent measurement signal 806 of the photon detector 302. In other words, the raw image data 112 in each case include a time course 808 of a photon count or a photon histogram 810 as fluorescence lifetime data.

Accordingly, the apparatus 100 can be designed to calculate parameters 812 representative of a fluorescence lifetime based on the subset 802 of the raw image data 112 of the already read-out sub-region 114 and to replace the subset 802 of the raw image data 112 of the already read-out sub-region 114 with these parameters 812. Here, a suitable parameter 812 is the time value τ_{i,j}, which indicates the average time that a molecule of the fluorophore remains in an excited state after external excitation before it emits a photon and thus returns to the ground state. For example, the method described in European patent application No. 21155585.9 from paragraph onwards can be used to calculate the time value τ_{i,j}. EP 3465156 A1 and EP 3752818 A1 also adequately describe the parameter calculation.

The calculated time values τ_{i,j} are output as processed image data 116 from the apparatus 100.

Finally, the apparatus 100 is designed to provide the processed image data 116 for display for access from outside the apparatus 100. In particular, the apparatus can be designed to assemble the processed image data 116 generated from already read-out sub-regions 114 into at least one continuously updated digital partial image 120 of the image 104 or complete image 150. As soon as all sub-regions 114 have been read out, the processed image data 116 can also be combined to form the complete image 150. The aforementioned updating of the filter mask 128 can also be effected from partial image 120 to partial image 120 and/or from complete image 150 to complete image 150.

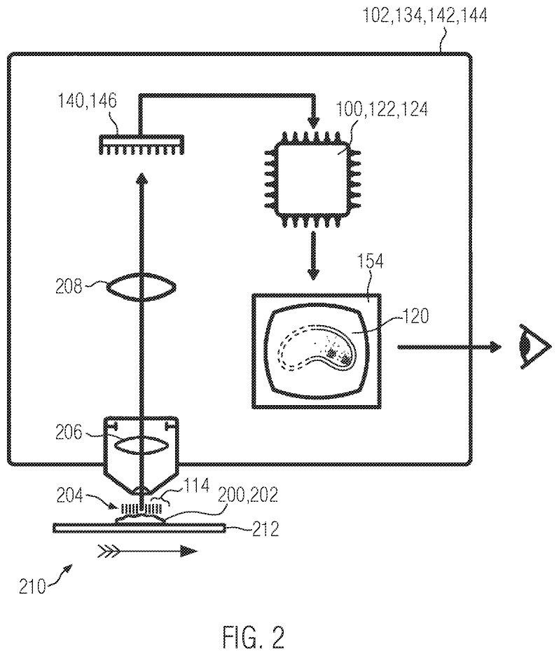

As shown in FIGS. 1 and 2, the microscope 134 can have at least one external and/or internal display screen 154, which is designed to graphically display the processed image data 116. For example, the aforementioned digital partial image 120 can appear as a preview on the display screen 154.

Furthermore, it can be seen from FIG. 1 that the microscope 134 can have an illumination device 148. In turn, the apparatus 100 can be designed to remove an error of illumination from the raw image data 112 upon generating the processed image data 116. For example, the aforementioned filter mask 128 can be adjusted in real time based on the calculated illumination error. If the illumination error persists despite the correction attempt, the apparatus 100 can be designed to recognize this and send a corresponding error message to the display screen 154.

In the following, the sequence of the microscopy method for scanning the sample volume 132 and generating the image 104 of the sample volume 132 built up raster-element-by-raster-element is explained with reference to FIGS. 6 and 7.

After sample preparation and device setting (step 600), the reading out of the first sub-region 114 is started (step 602) by reading out the first raster element 108 of the first sub-region 114 (sub-step 604). As long as not all raster elements 108 of the first sub-region 114 have been read out, the next raster element 108 is read out (loop return 606) in each case. Here, the next raster element 108 in each case can belong to the first sub-region 114. However, the next raster element 108 in each case can also be a raster element 108 outside the first sub-region 114, which is merely located in the same row or column as the previously read-out raster element 108.

The inner loop 608 shown can only be exited (loop output 610) if all raster elements 108 of the first sub-region 114 have been read out. The raw image data 112 from the first sub-region 114 is now forwarded 612 to and processed 614 by the apparatus 100. As shown in the detailed view of FIG. 7, the raw image data 112 can initially be received by the apparatus 100 (step 702). This is followed by the at least one processing step 118 in the form of the filtering 126, noise suppression 700, fluorescence lifetime data calculation 704 and/or other image processing processes explained above. Finally, the output 706 of the processed image data 116 is effected.

This processing 614 in the steps 702 to 706 is repeated for each sub-region 114 of the complete raster 110 and runs while the raster elements 108 of the respective next sub-region 114 in each case are read out in parallel. This is because as long as not all sub-regions 114 of the complete raster 110 have been read out, the process will move on to the raster-element-by-raster-element reading out 602 of the next respective sub-region 114 (loop return 616) in each case. The result of processing 614 can in turn be added to the continuously updated digital partial image 120 mentioned above (step 618). Only if all sub-regions 114 of the complete raster 110 have been read out can the outer loop 620 shown be exited (loop output 622) and the image 104 or complete image 150 be displayed (step 624).

The steps 612 to 624 can also be implemented as a computer-implemented method. Accordingly, a computer program 902 and/or a computer-readable storage medium 904 can comprise instructions that, when executed by a computer 906, cause the computer 906 to execute the steps 612 to 624.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

100 Apparatus
102 Imaging device
104 Image
106 Recording region
108 Raster element
110 Complete raster
112 Raw image data
114 Sub-region
116 Image data
118 Processing step
120 Partial image
122 Image processor
124 Circuit
126 Filtering
128 Filter mask
130 Sub-region
132 Sample volume
134 Microscope
136 Light intensity value
138 Detector element
140 Area image sensor
142 Light imaging microscope
144 Laser scanning microscope
146 Image sensor
148 Illumination device
150 Complete image
152 Matrix
154 Display screen
156 Array
158 Control unit
160 Microscope attachment
200 Object
202 Specimen
204 Scanning point
206 Objective
208 Lens
210 Adjustment mimic
212 Microscope stage
300 Pinhole aperture
302 Photon detector
304 Light intensity value
306 Mirror mechanism
400 Pixel
402 Photodiode
500 Area detector
502 Upper raster
504 Lower raster
506 Subset
508 Region
600 Step
602 Step
604 Sub-step
606 Loop return
608 Loop
610 Loop output
612 Forwarding
614 Processing
616 Loop return
618 Step
620 Loop
622 Loop output
624 Step
700 Noise suppression
702 Step
704 Fluorescence lifetime data calculation
706 Output
800 Metadata
802 Subset
804 Partial set
806 Measurement signal
808 Time course
810 Photon histogram
812 Parameter
900 Component
902 Computer program
904 Storage medium
906 Computer

1. An apparatus for data processing for a digital imaging device, the digital imaging device being configured to generate a digital image of a recording region by reading out, raster-element-by-raster-element, a multidimensional complete raster, the complete raster including a plurality of raster elements, wherein the apparatus is part of a control unit of the imaging device or is configured to be controllable by the control unit of the imaging device, and wherein the apparatus is configured to:
process raw image data from at least one sub-region of the complete raster that has already been read out during the reading out,
generate processed image data in at least one processing step as a function of the raw image data, and
make the processed image data available for display for access from outside the apparatus.

2. The apparatus according to claim 1, being configured to process the raw image data before the complete raster is completely read out.

3. The apparatus according to claim 1, being configured to assemble the processed image data generated from sub-regions that have already been read out into at least one continuously updated digital partial image of the digital image.

4. The apparatus according to claim 1, comprising an image processor embedded in the imaging device and/or at least one integrated circuit, and wherein the at least one processing step is executed in the embedded image processor and/or in the at least one integrated circuit.

5. The apparatus according to claim 1, wherein the at least one processing step comprises filtering the raw image data of the sub-region with a filter mask and/or noise suppression.

6. The apparatus according to claim 5, being further configured to update the filter mask in real time as a function of the raw image data of the sub-region that has already been read out and/or a geometry of the sub-region.

7. The apparatus according to claim 1, being configured to assign metadata to the at least one sub-region, the metadata being calculated as a function of raw image data linked to each raster element of the at least one sub-region.

8. The apparatus according to claim 7, being configured to replace the raw image data linked to each raster element of the at least one sub-region with the metadata.

9. The apparatus according to claim 1, wherein at least a subset of the raw image data of each raster element of the complete raster is representative of a time-dependent measurement signal of a photon counter, and wherein the apparatus is configured to calculate parameters representative of a fluorescence lifetime based on the subset of the raw image data of the sub-region that has already been read out and to replace the subset of the raw image data of the sub-region with the parameters.

10. The apparatus according to claim 1, wherein the complete raster is representative of at least one sub-region of a sample volume of a microscope to be scanned, wherein the microscope is configured to scan the complete raster, and wherein at least a subset of the raw image data is representative of light intensity values measured during the scanning.

11. The apparatus according to claim 1, wherein the complete raster is formed by detector elements of an area image sensor, wherein the sub-region is formed by a subset of the detector elements.

12. The apparatus according to claim 1, wherein each raster element of the complete raster itself comprises a lower raster, and the apparatus is configured to process the raw image data from a changeable region of the lower raster.

13. A digital light imaging microscope comprising an apparatus according to claim 1 and a sample volume, wherein the complete raster is representative of a sub-region of the sample volume, and wherein the digital light imaging microscope is configured to scan the complete raster and to generate an image of the sub-region of the sample volume, built up raster-element-by-raster-element.

14. The digital light imaging microscope according to claim 13, further comprising an image sensor having a plurality of detector elements arranged in a lower raster, and wherein the digital light imaging microscope is configured to generate the raw image data as a function of measured values of the detector elements of the image sensor on each raster element of the complete raster.

15. The digital light imaging microscope according to claim 13, further comprising an illumination device, and the apparatus is configured to remove an error of illumination from the raw image data upon generating the processed image data.

16. A microscopy method for scanning a sample volume and generating an image of the sample volume built up raster-element-by-raster-element, the microscopy method comprising, during scanning in real time:
processing raw image data representing at least one sub-region of the sample volume,
generating processed image data in at least one processing step based on the raw image data, and
making the processed image data available for display.
